(19) United States
(12) Patent Application Publication
(10) Pub. No.: US 2008/0279538 A1
(43) Pub. Date: Nov. 13, 2008

(54) Dvd Reading Apparatus

(75) Inventor: Holger Pless, Erfurt (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Melexix V, leper (BE)

(21) Appl. No.: 11/629,553

(22) PCT Filed: Jun. 20, 2005
(86) PCT No.: PCT/IB05/01732

§ 371 Date: May 5, 2008

(30) Foreign Application Priority Data
Jun. 22, 2004 (GB) 0413937.4

(51) Int. Cl. H04N 5/00

(52) U.S. Cl. 386/126; 386/E05.001

(57) ABSTRACT

A DVD reading apparatus has a plurality of photodiodes 201 operable to detect light of a specific wavelength reflected from the surface of a DVD. Each photodiode 201 is connected between a positive supply rail and a current mirror arrangement comprising transistors 204, 205, 207 and amplifier 202. The current mirror arrangement is operative to receive an input at the collector of transistor 204 and to generate two outputs identical to the input, a first output at the collector of transistor 205 and a second output at the collector of transistor 207. The first output is connected to an amplification arrangement 206 the output of which is passed to a processing means (not shown) along with the outputs of the amplification arrangements of each other photodiode 201. The second output of each current mirror arrangement, the collector of transistor 207 is output to a common multi-input summing amplifier 209 via an individual buffer arrangement. Each individual buffer arrangement comprises a transistor 221-218, the output being connected to the emitter of said transistor 211-218. The inputs to the common summing amplifier 209 are connected to the collector of each transistor 211-218.

The invention relates to reading data from a DVD and more particularly to apparatus for reading data from a DVD.

On a DVD, data is encoded in a spiral track on the DVD surface. DVD reading apparatus operates by directing a narrow beam of light, typically generated by an LED, VCSEL, or laser diode, at the spiral track of a spinning DVD. Sections of the track have varying reflective properties, such that a light sensing means provided in a particular position will detect a series of variations (or pulses) in the intensity of the reflected light. The light sensing means thus generates an electrical output signal corresponding to the data stored on the DVD. In order that the output of the light sensing means is suitable for input to any external device, it is passed through amplification and processing means to generate a true, accurate and reliable output data stream.

A typical DVD reader uses four photodiodes arranged in a square array to detect the reflected light from the track, to improve the accuracy of the reader. Enhanced readers may use up to eight photodiodes with more complex optical arrangement to further improve reading accuracy. In readers such as these wherein there are multiple photodiodes, each photodiode generates an independent data stream, which is input into a processing means along with the independent data streams generated by the other photodiodes, in order that the processing means may generate an accurate output data stream. The use of multiple photodiodes in this manner, allows the reader to extract true data from the DVD even under extreme conditions of mechanical tolerance and optical path degradation. In addition to the output data stream, a timing or clock signal is typically generated using phase lock means by summing the independent outputs of all the photodiodes.

In one known DVD reading apparatus, light in the red region of the spectrum with a wavelength of approximately 650 nm is reflected from the DVD and detected by an array of eight photodiodes, each adapted to detect light of wavelength 650 nm. Each photodiode is electrically connected between ground and an individual amplification arrangement and thereby generates an output signal to the individual amplification arrangement corresponding to the intensity of the detected light.

Each individual amplification arrangement comprises a trans-impedance amplifier, connected to the output of the photodiode and a voltage amplifier connected to the output of the trans-impedance amplifier. Typically the trans-impedance amplifier will have a gain of around 50 dB. The output of the voltage amplifier is the independent data stream for one photodiode as described above, and is input to processing circuitry, in parallel with the independent data streams from each other photodiode to generate an accurate output data stream. In addition to being connected to a voltage amplifier, the output of each trans-impedance amplifier is also connected to one input of a common eight input summing amplifier. The common summing amplifier sums the outputs of each of the eight trans-impedance amplifiers to provide a common output signal for timing or clock purposes as described above.

In an improvement on the above system, blue light, typically of around 405 nm in wavelength is used to read the DVD. As with the known system described above, an array of eight photodiodes, each photodiode being connected to an amplification arrangement comprising a trans-impedance amplifier and a voltage amplifier in series, are used to detect the reflected light and output independent signals to processing circuitry. Additionally as in the previous example, the output of the trans-impedance amplifier is fed to both the voltage amplifier and to a summing amplifier operable to generate a combined clock signal. In such systems, the output of the trans-impedance amplifier may be input to a current mirror arrangement operable to provide two outputs, each output being identical to the input, one output being fed to the voltage amplifier, the second output being fed to the common summing amplifier.

The use of blue light, because of its reduced wavelength compared to red light allows data to be read from a DVD at a faster rate However, the increased speed at which data may be read also requires that the amplification arrangement is able to cope which such increased speeds. This can be a problem particularly in respect of generation of the common output, as the input of eight or more signals into a single common amplifier may produces a large input load which reduces the operating speed of the summing amplifier. Additionally, a blue light photodiode typically generates 0.25 A/W as compared with 0.45 A/W for a red light photodiode. This being the case, the gain of the amplification arrangement must be increased to retain the desired level of accuracy in reading data. Furthermore, use of a blue light source necessitates a bipolar manufacturing process, which increases the cost of such DVD readers.

It is therefore an object of the present invention to provide a DVD reading apparatus which overcomes or alleviates the above problems.

According to the present invention there is provided a DVD reading apparatus comprising:

a plurality of photodiodes, each photodiode generating an output signal, each said output signal being input to an amplifier arrangement, said amplifier arrangement being adapted to output an independent amplified output signal for each individual photodiode, and each said output signal also being input to a common summing arrangement, the summing arrangement being operable to output a single combined output signal for all the photodiodes, characterised in that the output of each individual photodiode is input to the common summing arrangement via an individual impedance matched buffer arrangement.

This thus provides a low cost DVD reading apparatus with fast read speed and high read accuracy. Such a DVD reading apparatus can provide an improvement in gain, bandwidth and a noise improvement of up to 5 dB over known DVD reading apparatus.

Preferably, a current mirror is provided between each photodiode, each individual summing arrangement and each individual buffer arrangement. Most preferably, the current mirror is adapted to receive an input from the photodiode and to generate two outputs, each output identical to the input, the first output being input to the individual amplification arrangement and the second output being input to the common summing arrangement via the individual buffer arrangement.

Preferably, the photodiode is connected between a positive supply rail and the current mirror. Alternatively, the photodiode may be connected between ground and the current mirror.

Preferably, the summing arrangement comprises a multi-input summing amplifier, a dedicated input being provided for each photodiode said summing amplifier adapted to receive an input from the buffer arrangement associated with each photodiode. Preferably, each buffer arrangement is impedance matched with the summing arrangement.

Preferably, the buffer arrangement comprises a transistor. Most preferably, the transistor is operable in common base mode wherein the input to the buffer arrangement is the emitter of said transistor and the output of the buffer arrangement is the collector of said transistor.

The individual amplification arrangements may comprise any suitable combination of trans-impedance and or voltage amplifiers. Preferably said amplification arrangements comprise a trans-impedance amplifier in series with a voltage amplifier, the output of the photodiode being input to the trans-impedance amplifier and the output of the trans-impedance amplifier being input to the voltage amplifier in turn.

Preferably, the DVD reading apparatus comprises eight photodiodes. In alternative embodiments other numbers of photodiodes may be used, if desired.

Preferably, the photodiodes are adapted to detect light having a wavelength in the blue region of the spectrum, say 405 nm. Alternatively however, the photodiodes may be adapted to detect light having a wavelength in the red, say 650 nm, or infrared, say 780 nm, regions of the spectrum.

In order that the invention is more clearly understood, it will now be described further herein, by way of example only and with reference to the following drawings in which:

FIG. 1 shows a schematic view of known circuitry for reading a DVD;

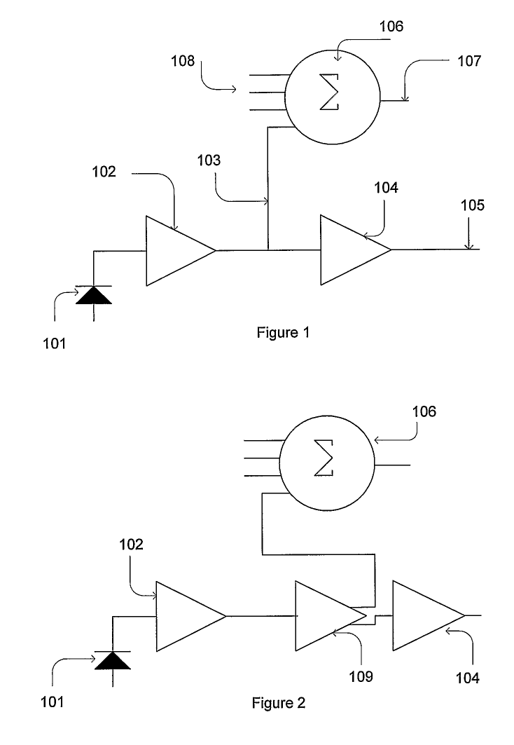

FIG. 2 shows a schematic view of alternative known circuitry for reading a DVD; and

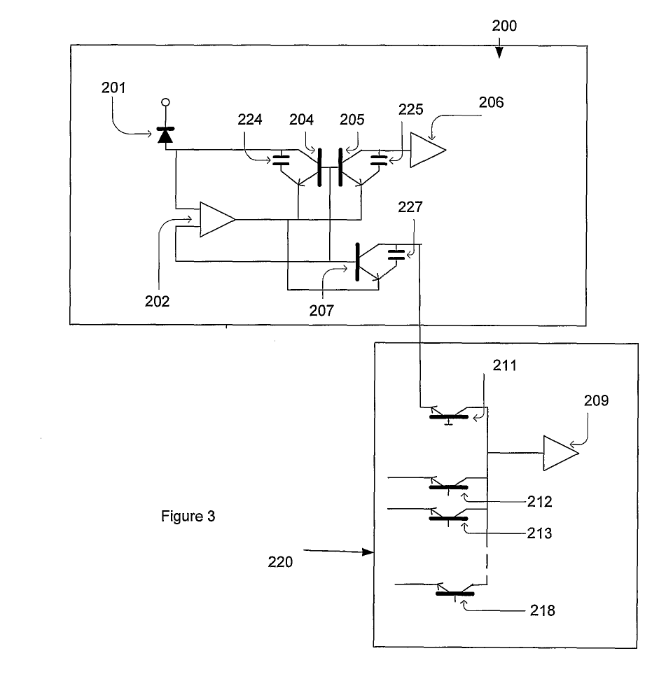

FIG. 3 shows a schematic view of circuitry for reading a DVD according to the present invention.

Referring now to FIG. 1, in a known DVD reading apparatus, a photodiode 101 detects light, with a wavelength of around 650 nm, reflected from the surface of a DVD. The photodiode 101 is one of eight photodiodes 101 positioned to detect such reflected light. The output of each photodiode 101 passes through an individual amplification arrangement comprising a trans-impedance amplifier 102 acting as a buffering amplifier in series with a voltage amplifier 104 operable to provide an independent output signal, 105, for each individual photodiode 101. The independent output signals 105, for each photodiode 101 are fed into suitable processing circuitry in parallel, to generate an output data stream. The output of each trans-impedance amplifier 102 is additionally directed, via connection 103, to an input 108 of a common multi-input summing amplifier 106. The common summing amplifier 106 receives outputs from each photodiode 101 to provide a common output signal, typically used for clock or timing purposes.

Referring now to FIG. 2, in an improved known DVD reading apparatus, blue light with a wavelength of 405 nm or similar is reflected from a DVD. In such apparatus, blue light sensitive photodiodes 101 are used rather than red light sensitive photodiodes. In general, this apparatus is similar to that shown in FIG. 1 and thus like reference numerals have been used for like components, however one major difference is that a current mirror 109 is introduced between the trans-impedance amplifier 102 and the voltage amplifier 104. The current mirror 109 is adapted to receive an input from the trans-impedance amplifier 102 and to provide two outputs identical to the input, one output being fed to the voltage amplifier 104 and the other being fed to the common summing amplifier 106.

Referring now to FIG. 3, an improved DVD reading apparatus according to the present invention is shown. As in the known apparatus described above, a plurality of photodiodes 201 is provided, each photodiode 201 operable to detect light of a specific wavelength reflected from the surface of a DVD. In the present example, the photodiodes 201 are adapted to detect blue light with a wavelength of around 405 nm, however if desired the photodiodes 201 may be adapted to detect red light with a wavelength of around 650 nm or infrared light with a wavelength of around 780 nm or any other suitable wavelength.

The number of photodiodes 201 provided may be varied as desired. In a preferred embodiment however eight separate photodiodes 201 are provided. In FIG. 3, for the sake of clarity, only a single photodiode 201 and its associated amplification arrangement 200 are shown, although the system comprises eight individual photodiodes 201. Each photodiode 201 is connected between a positive supply rail and a current mirror arrangement comprising transistors 204, 205, 207 and amplifier 202. Capacitors 224, 225, 227 represent the inherent capacitance of the transistors 204, 205, 207 respectively together with any capacitance associated with the layout of and the interconnections between the transistors 204, 205, 207. The capacitance is dependent upon layout of the transistors 204, 205, 207 and the associated interconnections

The current mirror arrangement is operative to receive an input at the collector of transistor 204 and to generate two outputs identical to the input, a first output at the collector of transistor 205 and a second output at the collector of transistor 207. The first output is connected to an amplification arrangement 206. The amplification arrangement may comprise a single amplifier but more typically comprises a trans-impedance amplifier in series with a voltage amplifier, the first output of the current mirror arrangement being input to the trans-impedance amplifier, and the output of the trans-impedance amplifier being fed to the voltage amplifier in turn.

The output of amplification arrangement 206 is passed to a processing means (not shown) along with the outputs of the amplification arrangements of each other photodiode 201. The processing means receives each independent output signal from each amplification arrangement 206 and then generates by sum and difference a single channel output data stream representing the pattern of bits stored within the scanned track on the DVD. The output data stream may additionally contain information on tracking accuracy, if desired.

The second output of each current mirror arrangement, the collector of transistor 207 is output to a common multi-input summing amplifier 209 via an individual buffer arrangement. Each individual buffer arrangement comprises a transistor 221-218, the output being connected to the emitter of said transistor 211-218. The inputs to the common summing amplifier 209 are connected to the collector of each transistor 211-218.

In the example shown, the second output of the current mirror, the collector of capacitor 207 is connected to an individual buffer arrangement embodied by transistor 211. The transistor 211, reduces the load on the common summing amplifier 209 thus increasing its operating speed as is explained below.

Capacitor 227, represents the inherent capacitance of transistor 207 together with any capacitance associated with the local circuitry, typically this of the order of 0.7 pF. In an eight photodiode system, the second output from each current mirror associated with each photodiode would also typically be of this order. The total input load on the common summing amplifier 209 for an eight photodiode system would therefore be of the order of 5.6 pF (8×0.7 pF). Such loading adversely affects the speed of the common summing amplifier 209. The transistors 211-218 provide an impedance buffer which reduces the load on common summing amplifier 209 and thus improves its operating speed.

The use of a reading apparatus incorporating all the features of the present invention is thus able to provide an improvement in gain and bandwidth of the output data stream and additionally able to provide a noise improvement of around 5 dB.

It is of course to be understood that the invention is not to be restricted to the details of the above embodiments which are described by way of example only.

1. A DVD reading apparatus comprising:
a plurality of photodiodes, each photodiode generating an output signal, each said output signal being input to an amplifier arrangement, said amplifier arrangement being adapted to output an independent amplified output signal for each individual photodiode, and each said output signal also being input to a common summing arrangement, the summing arrangement being operable to output a single combined output signal for all the photodiodes, wherein the output of each individual photodiode is input to the common summing arrangement via an individual impedance matched buffer arrangement.

2. A DVD reading apparatus as claimed in claim 1 wherein a current mirror is provided between each photodiode, each individual summing arrangement and each individual buffer arrangement.

3. A DVD reading apparatus as claimed in claim 2 wherein the current mirror is adapted to receive an input from the photodiode and to generate two outputs, each output identical to the input.

4. A DVD reading apparatus as claimed in claim 3 wherein the first output of current mirror is input to the individual amplification arrangement.

5. A DVD reading apparatus as claimed in claim 4 wherein the second output of the current mirror is input to the common summing arrangement via the individual buffer arrangement.

6. A DVD reading apparatus as claimed in claim 2 wherein each photodiode is connected between a positive supply rail and the current mirror.

7. A DVD reading apparatus as claimed in claim 2 wherein each photodiode is connected between ground and the current mirror.

8. A DVD reading apparatus as claimed in claim 1 wherein the summing arrangement comprises a multi-input summing amplifier.

9. A DVD reading apparatus as claimed in claim 8 wherein a dedicated input to the summing arrangement is provided for each photodiode and said summing arrangement is adapted to receive an input from the buffer arrangement associated with each photodiode.

10. A DVD reading apparatus as claimed in claim 9 wherein each said buffer arrangement is impedance matched with the summing arrangement.

11. A DVD reading apparatus as claimed in claim 1 wherein said buffer arrangement comprises a transistor.

12. A DVD reading apparatus as claimed in claim 11 wherein the transistor is operable in common base mode.

13. A DVD reading apparatus as claimed in claim 11 wherein the input to the buffer arrangement is the emitter of said transistor and the output of the buffer arrangement is the collector of said transistor.

14. A DVD reading apparatus as claimed in claim 1 wherein said amplification arrangements comprise a trans-impedance amplifier in series with a voltage amplifier, the output of the photodiode being input to the trans-impedance amplifier and the output of the trans-impedance amplifier being input to the voltage amplifier in turn.

15. A DVD reading apparatus as claimed in claim 1 wherein the DVD reading apparatus comprises eight photodiodes.

16. A DVD reading apparatus as claimed in claim 1 wherein the photodiodes are adapted to detect light having a wavelength in the blue region of the spectrum.
